(19) United States
(12) Patent Application Publication
(10) Pub. No.: US 2014/0002615 A1
(43) Pub. Date: Jan. 2, 2014

(54) SYSTEM AND METHOD FOR CORRECTING BINOCULAR PHOTOGRAPHY WITH HOMOGRAPHIC TRANSFORMATIONS

(71) Applicant: Benjamin Hendricks, Sherman Oaks, CA (US)

(72) Inventor: Benjamin Hendricks, Sherman Oaks, CA (US)

(73) Assignees: Sony Pictures Technologies Inc., Culver City, CA (US); Sony Corporation, Tokyo (JP)

(21) Appl. No.: 13/756,097

(22) Filed: Jan. 31, 2013

Related U.S. Application Data
(60) Provisional application No. 61/667,135, filed on Jul. 2, 2012.

(51) Int. Cl. H04N 13/02

(52) U.S. Cl. CPC H04N 13/0203
USPC 348/47

(57) ABSTRACT

Apparatus and methods are provided to implement a technique for managing stereo images. In one implementation, a computer system corrects misalignments in native stereo plates, i.e., images recorded using two cameras for stereo imaging, using homographic transformations.

### CROSS-REFERENCE TO RELATED APPLICATIONS

This application claims benefit of priority from U.S. Provisional Patent Application Ser. No. 61/667,135, filed Jul. 2, 2012, entitled “CORRECTING BINOCULAR PHOTOGRAPHY WITH HOMOGRAPHIC PLATE TRANSFORMATIONS”, owned by the assignee of the present application and herein incorporated by reference in its entirety.

### BACKGROUND

Movies presented in 3-D are enjoying tremendous popularity. One way of achieving three-dimensional images is by way of stereography. In stereography two images are captured and presented to a user, one from a left camera and for the left eye of a viewer, and one from a right camera and for a right eye of a viewer. Stereography is one of the oldest ways of producing a 3-D image for a viewer.

However, one complaint commonly heard from viewers of 3-D images is that viewing such often results in annoyances such as headaches or nausea. Such complaints are often not intrinsically related to the 3-D nature of the viewing experience, but rather to improperly aligned or misaligned images, which result in images seen by the viewer's eyes not being where they would be in real life.

In more detail, natively-shot stereo content, where two cameras are capturing images together, employs a rig with two mounted cameras that are intended to be in exactly the same position except for their horizontal offset. In practice, however, no mount is perfect and thus errors can creep into images because the cameras may be oriented in non-parallel directions or have other rotational differences, where the term “rotational” is used in the sense of 3D rotations. In addition, the level of zoom may differ, as well as other discrepancies.

In more detail, referring to the prior art FIG. 1, a system 10 is illustrated in which first and second stereo cameras 12 and 14 are illustrated with respective lenses 16 and 18. The cameras 12 and 14 are mounted on a base 15. The cameras 12 and 14 are intended to be in every way alike and positioned in the same manner except for a horizontal displacement D that gives rise to the stereo effect.

Despite attempts to align the cameras in position and orientation, errors often creep in. For example, the camera 14 may actually have the orientation of camera 14′, and thus be pointing in a slightly different direction than camera 12, i.e., their orientations may be nonparallel. It is noted that in FIG. 1 errors in camera positioning are exaggerated to make them more apparent. In the same way, camera 14″ is pointing at a slightly different direction than camera 14 and is also rotated about an axis perpendicular to the plane of the lens.

Addressing these errors is of great concern to filmmakers. For example, the vertical positioning of the cameras is of significant importance in reducing annoyances to users. Other errors including rotational differences or zoom or scale differences that may also be highly significant.

Besides actual film cameras, in order to properly make CG elements appear on images in an image, a set of respective virtual cameras 22 and 24 may be associated with the stereo cameras 12 and 14. The set of virtual cameras 22 and 24 are generally positioned such that their image planes are coincident with those of the respective cameras 12 and 14, although for certain visual effects the virtual cameras may be situated differently, e.g., with a different horizontal spacing, to provide a CG element with a different amount of dimensionality.

To properly place the CG cameras at the position of the physical stereo cameras, a variety of the “match move” technique is employed that leads to “camera extraction”, or determination of the location of the camera. Camera extraction is generally done with respect to each separate camera, and thus rotational differences between the physical stereo cameras will be propagated to the respective virtual cameras.

Whether from an actual filmed scene or from a CG model, rotational and other differences, however minor, can serve as visual distractions in viewing stereo content, making content difficult to view in stereo. Accordingly, a need exists for an improved 3-D viewing experience.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

In one implementation, a computer system adjusts images, such as to correct alignment between stereo images, to address the above-noted deficiencies of the prior art. The system corrects misalignments in native stereo plates using homographic transformations. The system calculates camera positions and orientations, such as by using match move data to extract camera positions. The system then determines how the camera rotations should change in order to have the desired alignment. In one implementation, the system uses perspective or nodal shifts to address a rotational correction.

In parallel with making these rotational changes for the cameras, the system may unwarp the corresponding plate photography and then apply the equivalent homographic transformations to the unwarped stereo plates. The operation may work in a similar manner to a corner pin. Generally the system and method correct for perspective shifts, i.e., nodal pans, but not for transformation differences or translations, although the system and method may work in tandem with systems and methods that do correct for these. The system and method may also address cases of keystoning.

In one aspect, the invention is directed towards a method for correcting stereo images, including: determining a position of a first camera; determining an orientation of the first camera; determining a position of a second camera; determining an orientation of the second camera; determining a difference between the first camera and the second camera based on the position of the first camera, the orientation of the first camera, the position of the second camera, and the orientation of the second camera; and performing a homographic transformation to adjust the orientation of the second camera based on the rotational difference.

Implementations of the invention may include one or more of the following. The determining the difference may include determining a perspective shift between the first camera and the second camera. The first camera may be a first physical camera and the second camera may be a second physical camera, and the method may further include providing a first virtual camera and a second virtual camera, the first virtual camera having a location and orientation coincident with the first physical camera, and the second virtual camera having a location and orientation coincident with the second physical camera, and the determining a difference may be based on the position of the first virtual camera, the orientation of the first virtual camera, the position of the second virtual camera, and the orientation of the second virtual camera. The method may further include performing a homographic transformation to adjust the orientation of the first or second virtual camera based on the difference. The determining a position of a first camera and the determining a position of the second camera may be performed using a step of match moving. The performing a homographic transformation to adjust the orientation of the second camera may include performing a nodal rotation of the second camera. The performing a homographic transformation may include adjusting a scale or zoom of images from the second camera. The method may further include receiving a series of first images from the first camera; receiving a series of second images from the second camera; and un-warping the series of first images and un-warping the series of second images prior to the step of determining a difference and performing a homographic transformation.

In another aspect, the invention is directed towards a non-transitory computer-readable medium, including instructions for causing a computer environment to perform the above method.

In a further aspect, the invention is directed towards a module, implemented on a non-transitory computer-readable medium, for correcting stereo images, including: a position determination module for determining the position of a first and a second physical camera; an orientation determination module for determining the orientation of a first and a second physical camera; a difference determination module for determining a difference between the first physical camera and the second physical camera based on the position of the first physical camera, the orientation of the first physical camera, the position of the second physical camera, and the orientation of the second physical camera; and a homographic transformation module for adjusting the orientation of the second physical camera based on the rotational difference.

Implementations of the invention may include one or more of the following. The module may further include a virtual camera module for situating a first virtual camera at a position and orientation coincident with the first physical camera and a second virtual camera at a position and orientation coincident with the second physical camera. The module may further include a virtual camera homographic transformation module for adjusting the orientation of the first or second virtual camera based on the difference. The module may further include a match move module for at least determining camera position and orientation, and where the position determination module and the orientation determination module employ the match move module in their determinations. The module may further include an un-warping module for un-warping images from the first and second physical cameras prior to the difference determination module determining a rotational difference, where the adjustment module adjusts the orientation of the un-warped images. The adjustment module may be configured to perform a homographic transformation in scale or zoom, a nodal rotation, or a perspective shift.

Advantages of certain implementations of the invention may include one or more of the following. Significantly-improved stereo results may be obtained in a convenient fashion. Certain implementations of the system and method allow for addressing rotational differences early in a stereo film-making pipeline, allowing the improved results to be what is viewed by filmmakers during production. While some implementations of the system and method do not address translations or transformation differences, correcting rotational differences by itself leads to significantly improved results.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a prior art stereo system, indicating common errors in relative positioning between stereo cameras.

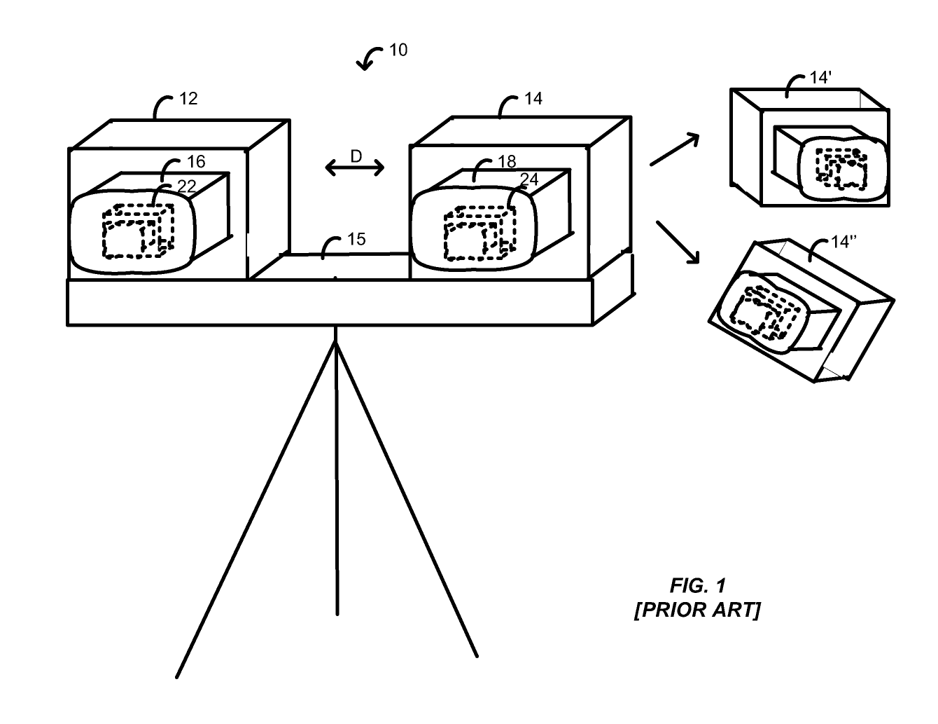

FIG. 2 is a flowchart illustrating a method according to principles disclosed here.

FIG. 3 illustrates an exemplary computing environment according to principles disclosed here.

FIG. 4 illustrates another exemplary computing environment in which systems according to principles disclosed here may be embodied and using which methods according to principles disclosed here may be carried out.

Like reference numerals refer to like elements throughout. Elements are not drawn to scale unless otherwise indicated.

### DETAILED DESCRIPTION

In a preferred embodiment, systems and methods according to certain implementations of the principles disclosed here relate to correcting for rotational differences in images as between stereo cameras. Rotational differences may also be addressed as perspective changes or nodal shifts. Rotational differences may include any differences which are caused by pivoting about a common optical center or pivot point. For example, if the camera was placed on a tripod and pivoted about the exact optical center or nodal center of its lens, then the changes experienced in view would be rotational in character. There would be no parallax shift. Elements would be seen to pan around the frame, but no elements would be uncovered or revealed by a parallax shift as the camera rotated. Besides rotational differences, zoom or scale differences may also be addressed. These types of changes addressed according to principles disclosed here are referred to as homographic transformations.

It is noted that the disclosed systems and methods need not adjust for parallax changes, as the same require additional data, i.e., a portion of the 3-D scene previously hidden by a barrier. However, the rotational differences addressed may be part of systems that also include ways to address parallax changes.

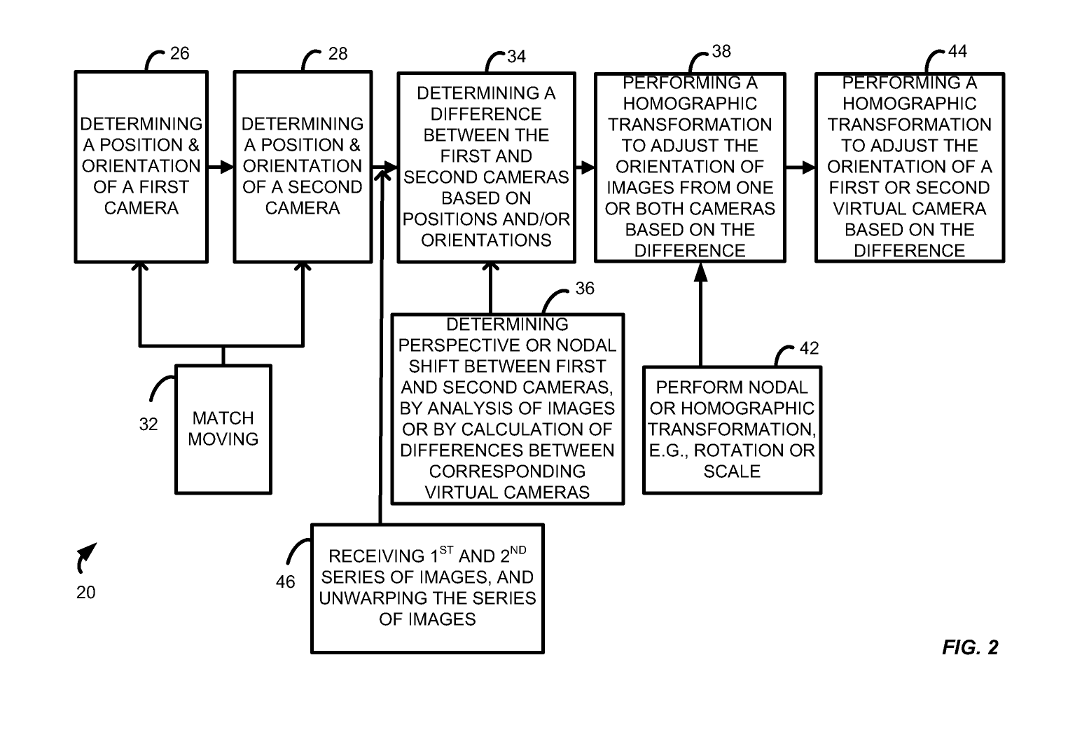

Referring to FIG. 2, a flowchart 20 is illustrated with a first step of determining a position and orientation of a first camera (step 26). A second step is illustrated of determining a position and orientation of a second camera (step 28). The steps may be accomplished by a step of match moving (step 32), although other techniques may also be employed.

A next step may then be to determine a rotational difference between the first and second cameras based on their positions and/or orientations (step 34). The rotational difference determined is generally a rotational difference in three dimensions, and thus may be thought of as rotations generally about the x-axis, y-axis, and/or z-axis. In some implementations, a step may be employed of not only receiving images to detect rotational differences, but doing so after a step of un-warping the received images (step 46).

In determining the rotational difference between the first and second cameras, a step may be employed of determining a perspective shift or a nodal shift between the first and second cameras (step 36).

The orientation of the images from one or both cameras may then be adjusted based on the determined rotational difference (step 38). In so doing, a nodal or homographic transformation may be performed on the one or both images (step 42). In an ancillary step, the orientation of the first or second virtual camera may also be adjusted based on the rotational difference (step 44).

In an alternative implementation, the step of determining a rotational difference between the first and second cameras may be based on analysis of the positions of corresponding virtual cameras. For example, if absolute differences are known or can be determined between the positions of the two virtual cameras, software including Maya® from Autodesk Incorporated of San Rafael, Calif., may be employed to detect the differences and then perform a nodal or homographic transformations on the virtual cameras. In the case of Maya® software, the same may be employed to detect and fix differences relating to orientation, rotation, focal length, and the like. The same transformation can then be applied to images from the physical stereo cameras.

Such transformations may include those similar to a corner pin, which are often used to address keystoning, which is the property of an object, or portion of an object, to appear larger if it is close to the viewer. As an example of a corner pin transformation, the appearance of a rectangular CG shape, if viewed from a direction not normal to the plane of the rectangle, is generally trapezoidal. In some cases, the vertical edges of the rectangle may remain vertical but the horizontal edges of the rectangle may appear to diverge or converge or both, depending on position of the viewer. In a corner pin transformation, the trapezoid may be transformed into a rectangle by extending the corners and spreading out a portion of the content of the picture. Even if this homographic transformation is only approximate, the overall effect of the image when viewed as part of a stereo pair is significantly enhanced.

While corner pin transformations are a very common subset of homographic transformations, one of ordinary skill in the art will understand that a variety of other techniques may also be employed. The transformations may include zoom differences, scale differences, focal length differences, or the like. In essence any transformation can be applied that is nodal in nature, i.e., can be accomplished by pivoting a camera about a pivot point, where the pivot point is located in the optical center of the camera, or by changing the lens focal length or film back properties (or equivalent ‘scale’ operations).

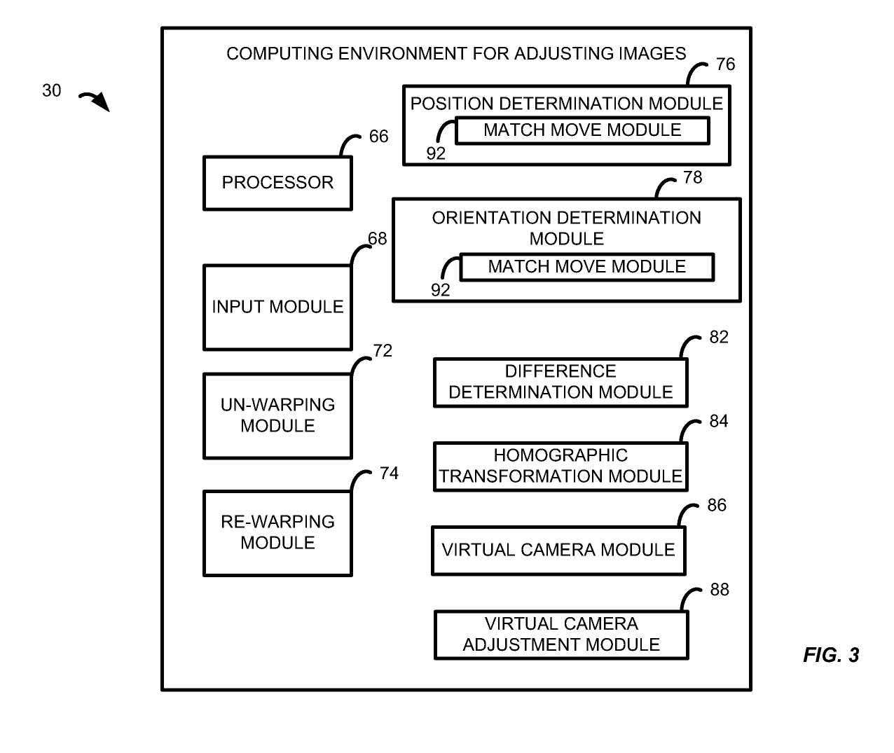

A modular computing environment 30 for adjusting images is illustrated in FIG. 3. The computing environment 30 may form a part of what is termed “department plate preparation” and may include a processor 66 and an input module 68, the input module 68 accepting stereo plates with alignment problems and details about virtual cameras with the same or similar alignment problems.

An un-warping module 72 may be employed to remove warping from images to allow a more accurate analysis to be performed thereon, as, e.g., actual straight lines will appear straight instead of curved in an unwarped image. In this way, more accurate match moving may be performed, or the like.

A virtual camera module 86 may be provided to implement virtual cameras at the same positions as physical stereo cameras, or at other positions as dictated by the artistic design.

A position determination module 76 and an orientation determination module 78 may be employed to determine the position and orientation of cameras. Each of these may employ a match move module 92 to extract camera information from images. Other techniques may also be employed.

A difference determination module 82 may be provided to detect a rotational or other nodal difference between stereo images. Other such nodal differences may include zoom, focal length, or the like. The difference determination module 82 may be stand-alone or may be embodied in another software application, such as in Nuke® (by The Foundry based in the United Kingdom). An adjustment module 84 may be employed to make adjustments to images according to the detected or determined rotational or other differences. In this way, images may be brought into alignment using homographic transformations. A virtual camera adjustment module 88 may be employed to transform the positions and orientations of corresponding virtual cameras.

A re-warping module 74 may be employed to re-warp the images to achieve a more natural-appearing image for a viewer and to preserve the natural characteristics of the original plate photography.

Other modules may be employed to address translation differences between images, and the same may perform steps not shown in the flowchart of FIG. 2. However, such modules and methods will benefit from certain implementations of the system and method disclosed here, as the disclosed systems and methods provide a better, cleaner, and more mathematically-correct starting point for such processes.

What has been described are systems and methods for adjusting images to provide for enhanced alignment between images from stereo cameras, as well as images portrayed by virtual or CG cameras.

One implementation includes one or more programmable processors and corresponding computer system components to store and execute computer instructions, such as to provide the tools for the determination of camera position and orientation as well as to apply homographic transformations to correct alignment. One such computing environment is disclosed below.

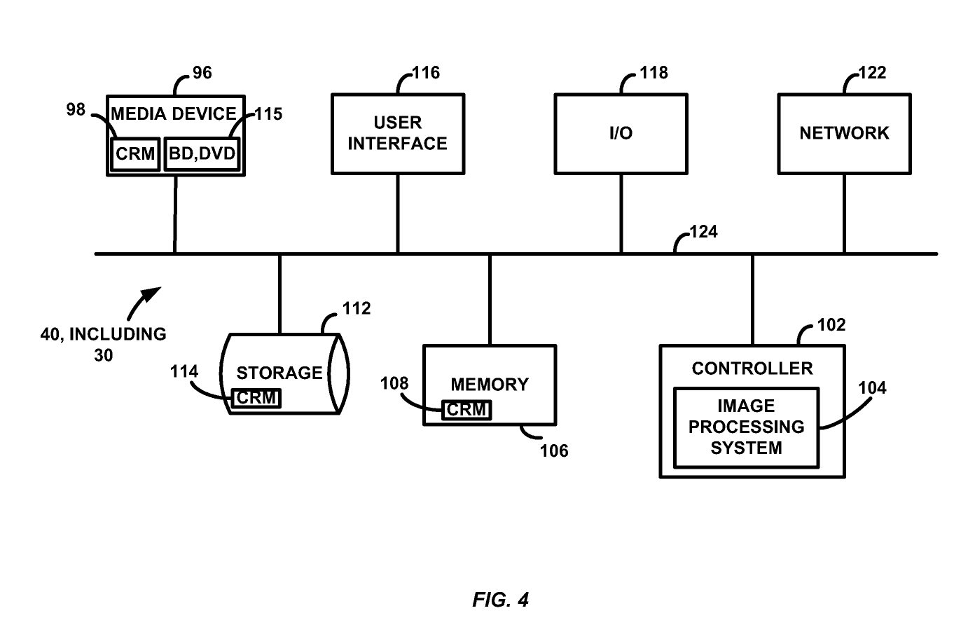

Referring to FIG. 4, a representation of an exemplary computing environment 40 for a stereo image processing workstation is illustrated.

The computing environment 40 includes a controller 102, a memory 106, storage 112, a media device 96, a user interface 104, an input/output (I/O) interface 106, and a network interface 108. The components are interconnected by a common bus 124. Alternatively, different connection configurations can be used, such as a star pattern with the controller at the center.

The controller 102 includes a programmable processor and controls the operation of an image processing system 104. The controller 102 loads instructions from the memory 106 or an embedded controller memory (not shown) and executes these instructions to control the system.

Memory 106, which may include non-transitory computer-readable memory 108, stores data temporarily for use by the other components of the system. In one implementation, the memory 106 is implemented as DRAM. In other implementations, the memory 106 also includes long-term or permanent memory, such as flash memory and/or ROM.

Storage 112, which may include non-transitory computer-readable memory 114, stores data temporarily or long-term for use by other components of the system, such as for storing data or instructions. In one implementation, the storage 112 is a hard disc drive or a solid state drive.

The media device 96, which may include non-transitory computer-readable memory 98, receives removable media and reads and/or writes data to the inserted media. In one implementation, the media device 96 is an optical disc drive or disc burner, e.g., a writable Blu-ray® disc drive 115.

The user interface 116 includes components for accepting user input, e.g., the user indication of artifacts or other aspects discussed above, and for presenting a display, e.g., of prior and subsequently transformed images, to the user. In one implementation, the user interface 116 includes a keyboard, a mouse, audio speakers, and a display. The controller 102 uses input from the user to adjust the operation of the computing environment.

The I/O interface 118 includes one or more I/O ports to connect to corresponding I/O devices, such as external storage or supplemental devices, e.g., cloud storage devices, a printer or a PDA. In one implementation, the ports of the I/O interface 118 include ports such as: USB ports, PCMCIA ports, serial ports, and/or parallel ports. In another implementation, the I/O interface 118 includes a wireless interface for wireless communication with external devices. These I/O interfaces may be employed to connect to one or more content playback devices.

The network interface 122 allows connections with the local network and includes a wired and/or wireless network connection, such as an RJ-45 or Ethernet connection or “Wi-Fi” interface (802.11). Numerous other types of network connections will be understood to be possible, including WiMax, 3G or 4G, 802.15 protocols, 802.16 protocols, satellite, Bluetooth®, or the like.

The system may include additional hardware and software typical of such devices, e.g., power and operating systems, though these components are not specifically shown in the figure for simplicity. In other implementations, different configurations of the devices can be used, e.g., different bus or storage configurations or a multi-processor configuration.

Various illustrative implementations of the present invention have been described. However, one of ordinary skill in the art will recognize that additional implementations are also possible and are within the scope of the present invention. For example, the disclosed systems and methods can be applied to images from movies, television, video games, etc.

Accordingly, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for correcting stereo images, comprising:
a. determining a position of a first camera;
b. determining an orientation of the first camera;
c. determining a position of a second camera;
d. determining an orientation of the second camera;
e. determining a difference between the first camera and the second camera based on the position of the first camera, the orientation of the first camera, the position of the second camera, and the orientation of the second camera; and
f. performing a homographic transformation to adjust the orientation of the second camera based on the rotational difference.

2. The method of claim 1, wherein the determining the difference includes determining a perspective shift between the first camera and the second camera.

3. The method of claim 1, wherein the first camera is a first physical camera and the second camera is a second physical camera, and further comprising a first virtual camera and a second virtual camera, the first virtual camera having a location and orientation coincident with the first physical camera, and the second virtual camera having a location and orientation coincident with the second physical camera, and wherein the determining a difference is based on the position of the first virtual camera, the orientation of the first virtual camera, the position of the second virtual camera, and the orientation of the second virtual camera.

4. The method of claim 3, further comprising performing a homographic transformation to adjust the orientation of the first or second virtual camera based on the difference.

5. The method of claim 3, wherein the determining a position of a first camera and the determining a position of the second camera is performed using a step of match moving.

6. The method of claim 1, wherein the performing a homographic transformation to adjust the orientation of the second camera includes performing a nodal rotation of the second camera.

7. The method of claim 1, wherein the performing a homographic transformation includes adjusting a scale or zoom of images from the second camera.

8. The method of claim 5, further comprising:
a. receiving a series of first images from the first camera;
b. receiving a series of second images from the second camera; and
c. un-warping the series of first images and un-warping the series of second images prior to the step of determining a difference and performing a homographic transformation.

9. A non-transitory computer-readable medium, comprising instructions for causing a computer environment to perform the method of claim 1.

10. A module, implemented on a non-transitory computer-readable medium, for correcting stereo images, comprising:
a. a position determination module for determining the position of a first and a second physical camera;
b. an orientation determination module for determining the orientation of a first and a second physical camera;
c. a difference determination module for determining a difference between the first physical camera and the second physical camera based on the position of the first physical camera, the orientation of the first physical camera, the position of the second physical camera, and the orientation of the second physical camera; and
d. a homographic transformation module for adjusting the orientation of the second physical camera based on the rotational difference.

11. The module of claim 10, further comprising a virtual camera module for situating a first virtual camera at a position and orientation coincident with the first physical camera and a second virtual camera at a position and orientation coincident with the second physical camera.

12. The module of claim 11, further comprising a virtual camera homographic transformation module for adjusting the orientation of the first or second virtual camera based on the difference.

13. The module of claim 12, further comprising a match move module for at least determining camera position and orientation, and wherein the position determination module and the orientation determination module employ the match move module in their determinations.

14. The module of claim 10, further comprising an un-warping module for un-warping images from the first and second physical cameras prior to the difference determination module determining a rotational difference, and wherein the adjustment module adjusts the orientation of the un-warped images.

15. The module of claim 10, wherein the adjustment module is configured to perform a homographic transformation in scale or zoom.

16. The module of claim 1510, wherein the adjustment module is configured to perform a nodal rotation.

17. The module of claim 10, wherein the adjustment module is configured to perform a perspective shift.
